(19) United States
(12) Patent Application Publication
(10) Pub. No.: US 2007/0220287 A1
(43) Pub. Date: Sep. 20, 2007

(54) Large current supply device for USB terminal device and connection structure for USB terminal device

(75) Inventor: Lee Sang-Heon, Seoul (KR)

Correspondence Address: DR. MARK FRIEDMAN LTD.;C/o Bill Polkinghorn, 9003 Florin Way, Upper Marlboro, MD, 20772, US

(73) Assignee: CMOTECH CO., LTD.

(21) Appl. No.: 11/402,895

(22) Filed: Apr. 13, 2006

(30) Foreign Application Priority Data
Mar. 16, 2006 (KR) 10-2006-0024154

(51) Int. Cl. G06F 1/00

(52) U.S. Cl. 713/300

(57) ABSTRACT

Disclosed is a device and a connection structure for stably supplying a necessary amount current from a USB host to a USB terminal device, which uses a current of at least 500 mA. A current adjust device has a means for equally distributing a current from the USB host to USB ports and prevents the USB ports from being damaged by an excessive current.

### BACKGROUND OF THE INVENTION

1. Field of the Invention

The present invention relates to a technology for connecting a USB terminal device to a host via a USB port and supplying a current from the host to the USB terminal device. More particularly, the present invention relates to a device and a connection structure for stably supplying a necessary amount current from a host to a USB terminal device, which uses a current of at least 500 mA, when the maximum amount of current available from the host via a standard USB port is limited to 500 mA.

2. Description of the Prior Art

A USB (universal serial bus) port is a type of serial port installed on a PC or laptop computer, for example, and acts as a plug-and-play interface for data communication and power supply between a peripheral device, such as keyboard, telephone, modem, scanner, or printer and the computer, which acts as a host. Although computers generally have two USB ports, more than two peripheral devices can be connected to a computer via a USB hub device, which divides each port into a number of ports. Each USB port has four contact lines, including two for data communication and two for power supply and grounding.

Particularly, a USB terminal device is operated by a current supplied from the host, each port of which can supply a current of 500 mA at most. Therefore, in the case of a device using a current of more than 500 mA, a separate external power supply device must be prepared.

There are three conventional methods for solving the problem of insufficient current, in the case of a USB terminal device using a current of more than 500 mA.

According to the first method, which is most widely used in the art, an external power supply device is used. However, this method has a problem in that, in addition to a cost increase, the large volume of the device makes it difficult to use the device while being carried.

The second method adopts an auxiliary battery for the device. However, this method is not suitable for a device, which is supposed to operate for a long period of time, because, when the energy stored in the battery is used up, the battery can not be used any longer. In addition, a separate means for charging the battery increases the cost.

Finally, a current is obtained from at least two hosts according to the third method. However, this method has a problem in that, when the current is concentrated in a specific USB port of a host, the host may be damaged physically.

### SUMMARY OF THE INVENTION

Accordingly, the present invention has been made to solve the above-mentioned problems occurring in the prior art, and an object of the present invention is to provide a device for supplying a USB terminal device, which uses a current of at least 500 mA, with a necessary amount of current from a conventional USB host.

Each port of a USB host has an internal power supply, in order to stably supply a current of maximum 500 mA at a voltage of 5V, and operates regardless of the current supply of other ports. When a USB terminal device is simultaneously supplied with currents from a number of ports, it can use a current as large as “500 mA×the number of ports,” in theory, since each port operates independently. In order to supply each port with an amount of current as given theoretically, an identical amount of current must flow through each port. Suppose that a current is supplied via two USB ports of host and, if a current of 700 mA flows through one port and 100 mA through the other, the former port of host may be damaged.

Therefore, it is another object of the present invention to provide a device for equally distributing a current, which is supplied from a USB host, to a USB terminal device.

In order to accomplish these objects, there is provided a connection structure for a USB terminal device including a USB host having at least two USB terminals (USB ports); a current adjustment device connected to the USB terminals of the USB host, the current adjustment device containing a current adjustment circuit adapted to adjust a current supplied from the USB terminals and supply a current of at least 500 mA to a USB terminal device; and the USB terminal device connected to the current adjustment device and supplied with power.

The USB host may be selected from a computer, a laptop computer, and a USB hub. Alternatively, the USB host may be a device having similar USB ports.

The current adjustment device preferably includes at least two first connection terminals connected to the USB terminals of the host; a current adjustment circuit electrically connected to the first connection terminals and adapted to equally distribute a current to the first connection terminals; and a second connection terminal connected to the USB terminal device and adapted to supply a current from the current adjustment circuit to the USB terminal device.

According to an embodiment of the present invention, the current adjustment circuit uses a serial resistor to adjust a current.

According to another embodiment of the present invention, the current adjustment circuit uses a serial resistor and a transistor having a switching function to adjust a current. Preferably, the current adjustment circuit uses a capacitor to limit an initial current.

Although a USB modem is given as the USB terminal device according to an embodiment described with reference to Table 1, but the type of the USB terminal device is not limited to that in the present invention.

In accordance with another aspect of the present invention, there is provided a large current supply device for a USB terminal device capable of supplying the USB terminal device with a current of at least 500 mA, the large current supply device including at least two first connection terminals connected to a USB host having at least two USB terminals for supplying a current of maximum 500 mA to an outside; a current adjustment circuit electrically connected to the first connection terminal and adapted to equally distribute a current to the first connection terminals; and one second connection terminal connected to the USB terminal device and adapted to supply a current from the current adjustment circuit to the USB terminal device, a current of at least 500 mA being supplied to the USB terminal device via the second connection terminal.

According to an embodiment of the present invention, the current adjustment circuit uses a serial resistor to adjust a current.

According to another embodiment of the present invention, the current adjustment circuit uses a serial resistor and a transistor having a switching function to adjust a current. Preferably, the current adjustment circuit uses a capacitor to limit an initial current.

### BRIEF DESCRIPTION OF THE DRAWINGS

The above and other objects, features and advantages of the present invention will be more apparent from the following detailed description taken in conjunction with the accompanying drawings, in which:

FIG. 1 shows a basic construction of a device according to the present invention;

FIG. 2 shows a circuit diagram of a current adjustment device according to an embodiment of the present invention;

FIG. 3 shows a circuit diagram of a current adjustment device according to another embodiment of the present invention;

FIG. 4 briefly shows an example of application of a device according to the present invention; and

FIG. 5 shows the characteristics of a port of a USB hub according to an embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

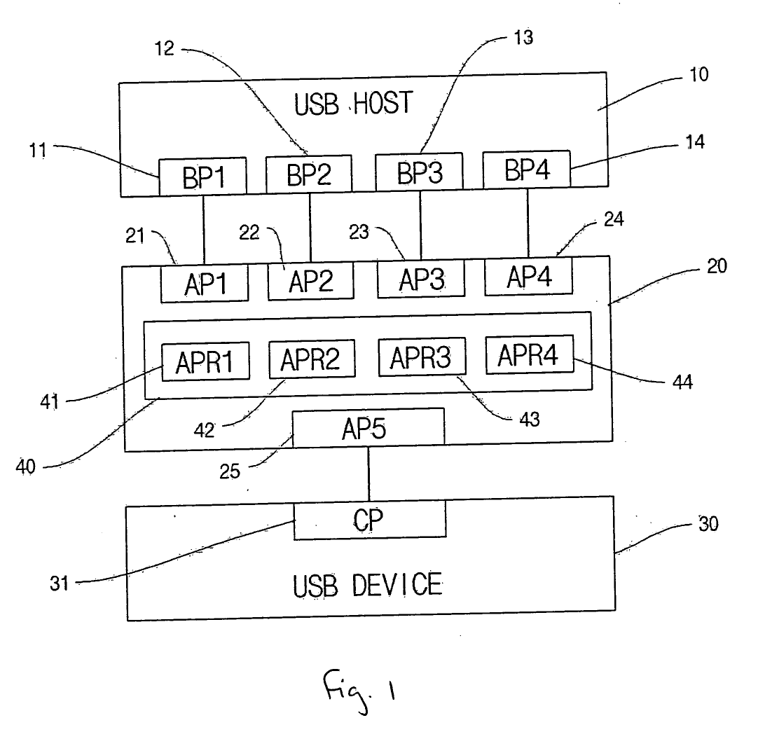

FIG. 1 shows a basic construction of a device according to the present invention. A current adjustment device 20 is connected to USB ports of a host 10, on the one hand, and to a USB terminal (USB ports) of a USB terminal device 30, on the other hand.

The current adjustment device 20 has first connection terminals, particularly AP1 21, AP2 22, AP3 23, and AP4 24, which are connected to corresponding terminals of the host 10, particularly BP1 11, BP2 12, BP3 13, and BP4 14. The first connection terminals are supplied with a current of maximum 500 mA from the USB host. The current adjustment device 20 has a second connection terminal, particularly AP5 25, which is connected to a USB terminal CP 31 of the USB terminal device 30. The second connection terminal supplies the USB terminal device 30 with a current of at least 500 mA. The current adjustment device 20 has internal components, particularly APR1 41, APR2 42, APR3 43, and APR4 44, which constitute a current adjustment circuit 40 for balancing the distribution of current and preventing an excessive current. Any number of sets can be selected from (AP1, APR1), (AP2, APR2), (AP3, APR3), and (AP4, APR4) and used depending on the amount of current needed by the USB terminal device. As such, a separate current adjustment device 20 is connected to a number of USB terminals of the host and supplied with a current of at least 500 mA from the host. The current adjustment circuit 40 balances the distribution of current to the USB ports so that a necessary amount of current, which is at least 500 mA, can be safely supplied to the USB terminal device 30. Since the current adjustment device 40 equally distributes the current to the first connection terminals 21, 22, 23, and 24, it is possible to prevent the USB ports, which are connected to the respective first connection terminals, from being damaged by an excessive current.

It is assumed, for convenience of description, that two sets (AP1, APR1) and (AP2, APR2) are used in the following description of embodiments of the present invention, and the same description holds when three or four sets are used.

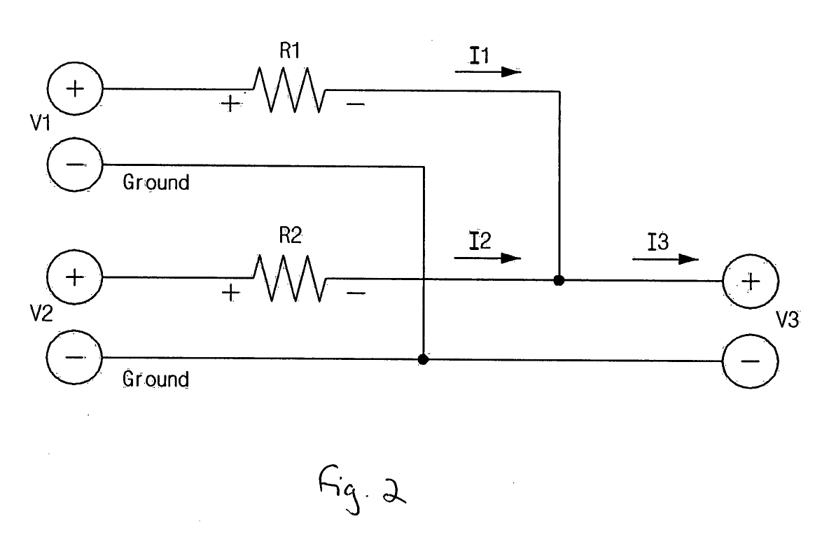

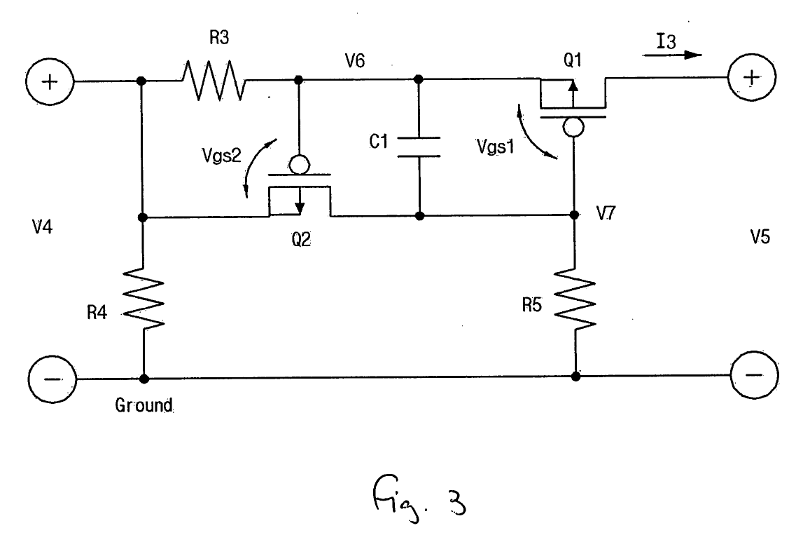

FIGS. 2 and 3 show the internal construction of the current adjustment circuits ARP1 and APR2, which may have the same circuit configuration and which are positioned inside the current adjustment device 20 so as to prevent an excessive current and equally distribute a current to the AP1 and AP2. Although the basic construction of the circuits shown in FIGS. 2 and 3 will be described herein, those skilled in the art can easily modify the construction, based on the characteristics of the USB host, without departing from the scope of the present invention.

FIG. 2 shows a basic circuit for distributing a current and preventing an excessive current by using the construction shown in FIG. 1. Currents I1 and I2 flow from voltages V1 and V2 to a voltage V3 via serial resistors R1 and R2, respectively. The voltages V1 and V2 supplied from USB ports have the same value of 5V (in general, there is a deviation of about 0.25V). When there exists a different in voltage (Vx=V2−V1) between two ports of a USB host, the difference in current (I1−I2) between the two ports is obtained as follows:
I3=I1+I2
I1=(V1−V3)/R1, I2=(V2−V3)/R2

When R1 and R2 have the same value of R,
I2−I1=Vx/R

As a result, the difference in current between the ports can be adjusted by varying the resistance value. This means that, by selecting suitable resistors based on the necessary amount of current, a similar amount of current can be obtained from both ports.

In FIG. 3, a serial resistor R3 plays the same role as the resistors R1 and R2 shown in FIG. 2, a transistor Q1 acts as a main switch for controlling 13, and a transistor Q2 acts as a protective circuit for preventing an excessive current. When a large amount of current 13 flows and the voltage Vgs2 acting on both ends of the resistor R3 increases, the transistor Q2 is turned on and toggles the transistor Q1 off so that the current is interrupted. The load associated with voltage V5 is generally a capacitive component and has a very large initial inrush current. A capacitor C1 is used to limit the initial current. A resistor R4 establishes a path, when the current adjustment device 20 shown in FIG. 1 is separated from the host 10, so that the discharge path of the capacitor C1 becomes R4-R3-C1-R5. A resistor R5 charges the capacitor C1 along a path R3-C1-R5 and, in a normal operating condition, reduces voltage V7 to 0V so that the transistor Q1 is turned on.

It is assumed that, when the circuit shown in FIG. 3 initially begins operating, the capacitor C1 has been discharged completely. This means that the transistor Q1 is turned off, and the current flows only through the path R3-C1-R5. Consequently, Vgs2 has a very small value, and the transistor Q2 is also turned off. As the capacitor C1 is charged, the transistor Q1 gradually turned on, and the current 13 increases in proportion to the load. In normal operating conditions, the transistor Q2 is turned off and the transistor Q1 is turned on so that current 13 is supplied. However, when the current 13 increases and the transistor Q2 is turned on, the transistor Q2 reduces Vgs1 of the transistor Q1 and limits the current 13.

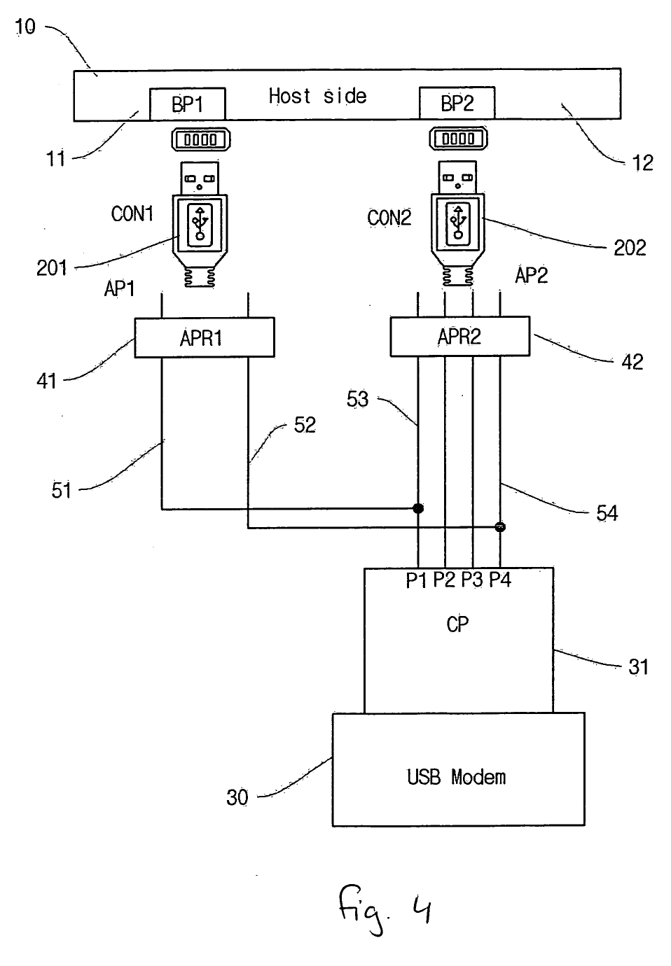

FIG. 4 shows the overall construction of a system for connecting a USB terminal device 30 to a host 10 via the current adjustment device 20 described above. The current adjustment device 20 contains USB connectors 201 and 202. The host 10 is a USB hub having USB ports (or the host 10 may be a PC having two USB ports). The USB terminal device 30 is a USB modem.

The USB connectors 201 and 202 contain current adjustment circuits APR1 41 and APR2 42, respectively. The USB modem has a USB A type female USB terminal 31, for example, a port of which has four contacts, including P2 (white) and P3 (green) for data communication, P1 (red) acting as a Vcc contact, to which power is applied from the host, and P2 (black) acting as a ground. The contacts P1, P2, P3, and P4 of the USB modem are electrically connected to the current adjustment circuit APR2 42 inside the USB connector, respectively, and perform data communication. In the case of the current adjustment circuit APR1 41, the contacts P2 and P3 are not connected thereto, but the contacts P1 and P4 are connected. As shown in FIG. 4, lines 51 and 52 of the USB connector 201, which are connected to the contacts P1 and P4, respectively, are connected to lines 53 and 54 of the USB connector 202, which are connected to the contacts P1 and P4, respectively.

In summary, the USB modem is connected to only power lines of the first USB connector 201, which contains a current adjustment device, but to both power and data lines of the second USB connector 202, which also contains a current adjustment device. The power lines of both USB connectors 201 and 202 are bridged to each other.

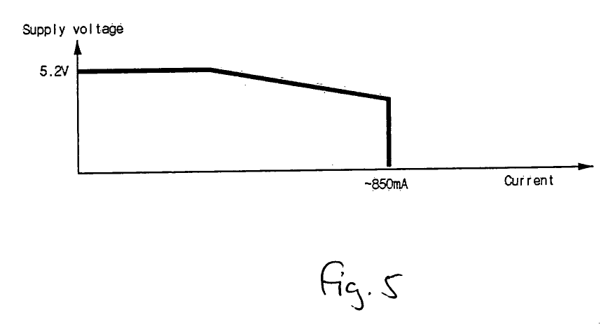

FIG. 5 shows the characteristics of a port of a self-powered USB hub (ATEN UH-204) as a result of experiment. It is clear from the drawing that the current is interrupted at a value of about 850 mA by a protective function of the hub itself. Following Table 1 provides the value of voltage and current of each port, as well as a current flowing through the USB modem, in the case of the embodiment shown in FIG. 4.

TABLE 1

| | Current (A) | | |
|---|---|---|---|
| Current adjustment | | CON 1 | CON 2 |
| device voltage (V) | CP current | current | current |
| 5.21 | 0.26 | 0.13 | 0.13 |
| 4.95 | 0.53 | 0.26 | 0.27 |
| 4.85 | 0.97 | 0.48 | 0.49 |

It is obvious from the table that a current is equally distributed to each port and, even when a current of 970 mA flows, the current of each port is adjusted to less than 500 mA. This shows an efficient current distribution function.

As mentioned above, the present invention is advantageous in that a current of at least 500 mA can be stably supplied to a USB terminal device.

In addition, when a current is supplied from each USB connector port to a USB terminal device, the current is equally distributed to the USB connector port, which is connected to the host. This prevents the USB ports from being damaged by an excessive current.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A connection structure for a USB terminal device comprising:
a USB host having at least two USB terminals;
a current adjustment device connected to the USB terminals of the USB host, the current adjustment device containing a current adjustment circuit adapted to adjust a current supplied from the USB terminals and supply a current of at least 500 mA to a USB terminal device; and
a USB terminal device connected to the current adjustment device and supplied with power.

2. The connection structure for a USB terminal device as claimed in claim 1, wherein the USB host is selected from the group consisting of a computer, a laptop computer, and a USB hub.

3. The connection structure for a USB terminal device as claimed in claim 1, wherein the current adjustment device comprises:
at least two first connection terminals connected to the USB terminals of the host;
a current adjustment circuit electrically connected to the first connection terminals and adapted to equally distribute a current to the first connection terminals; and
a second connection terminal connected to the USB terminal device and adapted to supply a current from the current adjustment circuit to the USB terminal device.

4. The connection structure for a USB terminal device as claimed in claim 3, wherein the current adjustment circuit uses a serial resistor to adjust a current.

5. The connection structure for a USB terminal device as claimed in claim 3, wherein the current adjustment circuit uses a serial resistor and a transistor having a switching function to adjust a current.

6. The connection structure for a USB terminal device as claimed in claim 3, wherein the current adjustment circuit uses a capacitor to limit an initial current.

7. The connection structure for a USB terminal device as claimed in claim 1, wherein the USB terminal device is a USB modem.

8. A large current supply device for a USB terminal device capable of supplying the USB terminal device with a current of at least 500 mA, the device comprising:
at least two first connection terminals connected to a USB host having at least two USB terminals for supplying a current of maximum 500 mA to an outside;
a current adjustment circuit electrically connected to the first connection terminal and adapted to equally distribute a current to the first connection terminals; and
a second connection terminal connected to the USB terminal device and adapted to supply a current from the current adjustment circuit to the USB terminal device, a current of at least 500 mA being supplied to the USB terminal via the second connection terminal.

9. The large current supply device for a USB terminal device as claimed in claim 8, wherein the current adjustment circuit uses a serial resistor to adjust a current.

10. The large current supply device for a USB terminal device as claimed in claim 8, wherein the current adjustment circuit uses a serial resistor and a transistor having a switching function to adjust a current.

11. The large current supply device for a USB terminal device as claimed in claim 8, wherein the current adjustment circuit uses a capacitor to limit an initial current.
